(19) United States
(12) Patent Application Publication
(10) Pub. No.: US 2024/0327666 A1
(43) Pub. Date: Oct. 3, 2024

(54) Set And Ink Jet Recording Method

(71) Applicant: SEIKO EPSON CORPORATION, Tokyo (JP)

(72) Inventor: Kosuke CHIDATE, Shiojiri (JP)

(21) Appl. No.: 18/616,293

(22) Filed: Mar. 26, 2024

(30) Foreign Application Priority Data
Mar. 27, 2023 (JP) 2023-049824

(51) Int. Cl. C09D 11/40; C09D 11/033; C09D 11/102; C09D 11/322; C09D 11/54; D06P 1/52; D06P 3/52; D06P 5/00; D06P 5/30

(52) U.S. Cl. CPC C09D 11/40; C09D 11/033; C09D 11/102; C09D 11/322; C09D 11/54; D06P 1/5285; D06P 1/5292; D06P 5/002; D06P 5/30; D06P 3/52

(57) ABSTRACT

Provided is a set including a reaction solution composition and an ink jet ink composition, in which the reaction solution composition contains a cationic urethane resin, a water-soluble organic solvent, and water, the ink jet ink composition contains a pigment, a crosslinkable urethane resin, and water, and the set is used to jet the reaction solution composition and the ink jet ink composition by an ink jet method to make the reaction solution composition and the ink jet ink composition adhere to a fabric.

The present application is based on, and claims priority from JP Application Serial Number 2023-049824, filed Mar. 27, 2023, the disclosure of which is hereby incorporated by reference herein in its entirety.

### BACKGROUND

### 1. Technical Field

The present disclosure relates to a set and an ink jet recording method.

### 2. Related Art

An ink jet recording method has been applied not only to recording images on a medium such as paper, but also to textile printing on fabrics, and various ink compositions and recording methods for ink jet textile printing also have been examined. For example, JP-A-2017-222793 describes, as an ink set used for an ink jet recording method, an ink set including an aqueous colored ink and an aqueous coating solution, in which the aqueous colored ink contains water, a self-dispersing pigment, a water-soluble solvent, and a resin, the aqueous coating solution contains water, a water-soluble solvent, and a resin, the resin contained in the aqueous coating solution contains a water-soluble polymer containing a quaternary ammonium cation, and the aqueous coating solution has a pH of 7.1 to 10.0.

However, when recording is performed on fabrics using the ink set described in JP-A-2017-222793, there is a problem in that wet rub fastness to fabrics is degraded. Further, an ink containing a crosslinkable urethane resin is not described at all in JP-A-2017-222793.

### SUMMARY

According to an aspect of the present disclosure, there is provided a set including: a reaction solution composition; and an ink jet ink composition, in which the reaction solution composition contains a cationic urethane resin, a water-soluble organic solvent, and water, the ink jet ink composition contains a pigment, a crosslinkable urethane resin, and water, and the set is used to jet the reaction solution composition and the ink jet ink composition by an ink jet method to make the reaction solution composition and the ink jet ink composition adhere to a fabric.

### BRIEF DESCRIPTION OF THE DRAWINGS

FIG. 1 is a flowchart showing an example of an ink jet recording method according to the present embodiment.

FIG. 2 is Table 1 showing compositions of reaction solution compositions of examples and comparative examples.

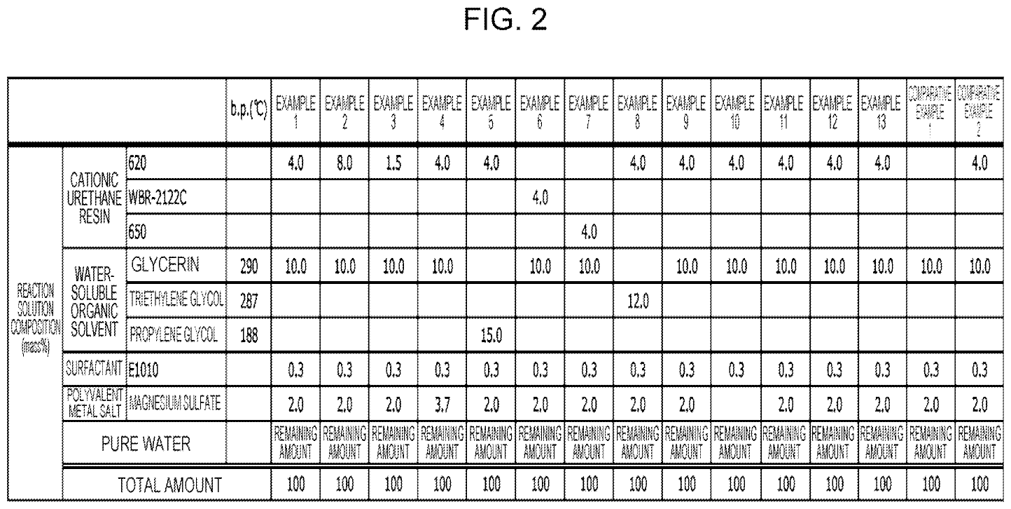

FIG. 3 is Table 2 showing compositions of ink jet ink compositions of the examples and the comparative examples.

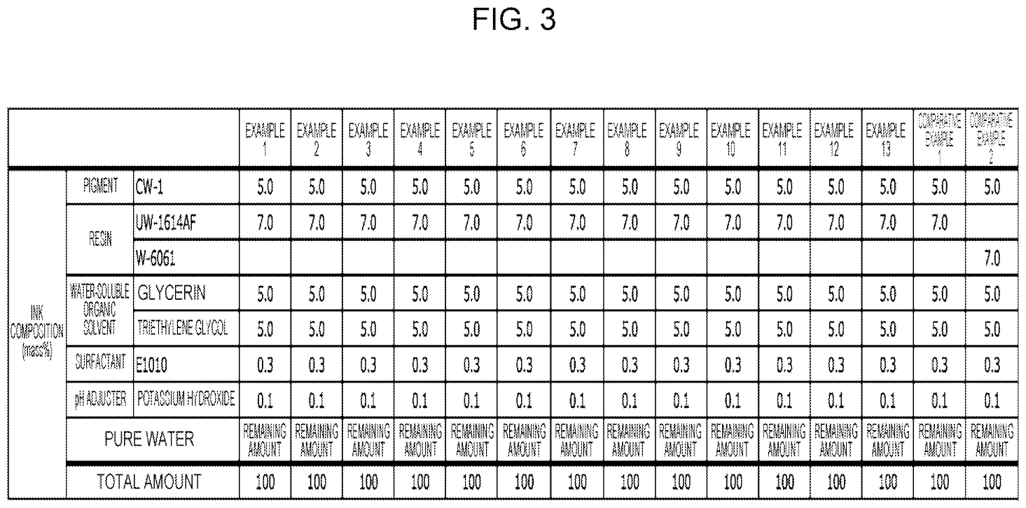

FIG. 4 is Table 3 showing compositions of post-treatment liquid compositions of the examples and the comparative examples.

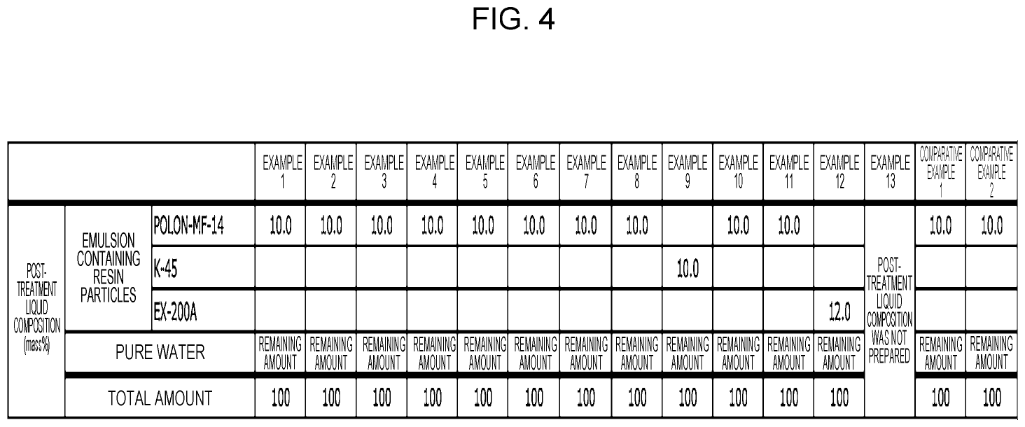

FIG. 5 is Table 4 showing drying conditions after application of the post-treatment liquid compositions of the examples and the comparative examples.

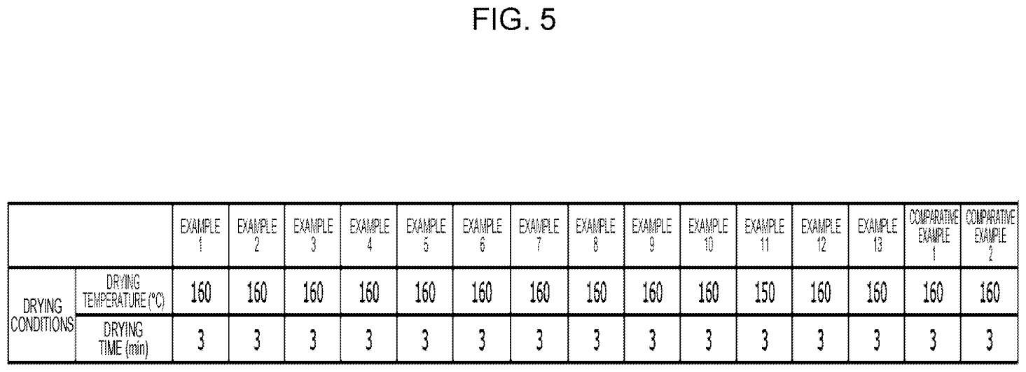

FIG. 6 is Table 5 showing evaluation results of the examples and the comparative examples.

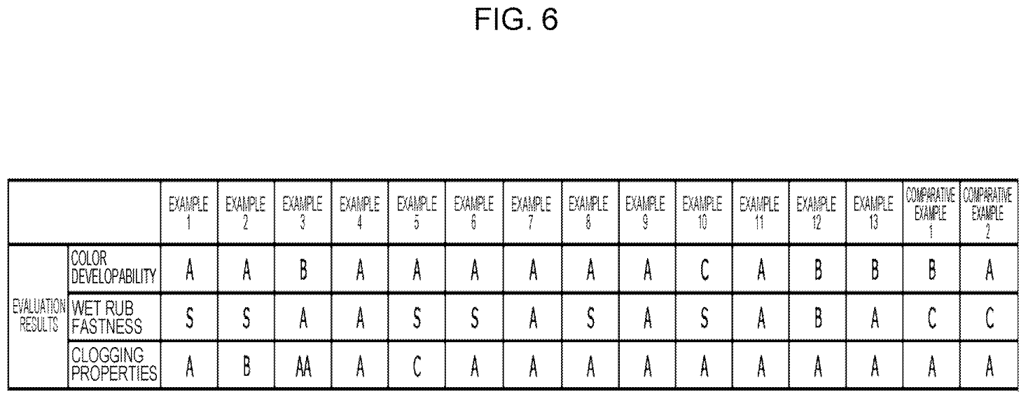

### DESCRIPTION OF EMBODIMENTS

Hereinafter, embodiments of the present disclosure (hereinafter, referred to as “present embodiment) will be described in detail, but the present disclosure is not limited thereto, and various modifications can be made within a range not departing from the scope of the present disclosure.

A set according to the present embodiment includes a reaction solution composition and an ink jet ink composition (hereinafter, also referred to as “ink composition”), the reaction solution composition contains a cationic urethane resin, a water-soluble organic solvent, and water, the ink composition contains a pigment, a crosslinkable urethane resin, and water, and the set is used to jet the reaction solution composition and the ink composition by an ink jet method to make the reaction solution composition and the ink composition adhere to a fabric. The set according to the present embodiment may further include a post-treatment liquid composition. It is preferable that the post-treatment liquid composition contain particles containing an organopolysiloxane, and water.

A printed material with excellent wet rub fastness can be obtained by using the set according to the present embodiment for a fabric. The reason why the excellent effects are obtained by the present embodiment as described above is not clear, but the present inventors have presumed as follows.

That is, the pigment in an ink composition is difficult to stay near the surface of a fabric because an ink composition typically has high permeability to a fabric. When a pigment contained in the ink composition has anionic properties, a treatment liquid composition containing a water-soluble polyvalent metal salt or a cationic compound is allowed to adhere to a fabric in advance so that the pigment, the water-soluble polyvalent metal salt, and the cationic compound are aggregated near the surface of the fabric, and therefore, the color developability is obtained in some cases.

However, when the aggregating properties of the pigment are not sufficient even in a case where a water-soluble polyvalent metal salt or a cationic compound is used, a water-soluble layer is formed between the pigment and the fabric, and thus interfacial peeling is caused. Therefore, a typical treatment liquid composition has poor wet rub fastness to a fabric. Further, this tendency is significant when polyester-based fibers are used as fabrics.

Therefore, according to the present embodiment, the reaction solution composition containing a cationic urethane resin, a water-soluble organic solvent, and water is jetted by an ink jet method and made to adhere to a fabric. Further, the ink composition containing a pigment, a crosslinkable urethane resin, and water is jetted by an ink jet method and made to adhere to a region to which the reaction solution composition is adhered. The interfacial peeling between the pigment and the fabric is suppressed by performing the above-described treatments on the fabric, and thus the adhesive strength at the interface is further improved. Therefore, according to the present embodiment, excellent wet rub fastness to a fabric is presumed to be obtained. However, the reason is not limited thereto.

Next, each component contained in the reaction solution composition, the ink composition, and the post-treatment liquid composition will be described.

### 1. Reaction Solution Composition

The reaction solution composition according to the present embodiment contains a cationic urethane resin, a water-soluble organic solvent, and water and is used to be jetted by an ink jet method and made to adhere to a fabric. It is preferable that the reaction solution composition be made to adhere to a fabric before the adhesion of the ink composition to the fabric.

### 1.1. Cationic Urethane Resin

The reaction solution composition contains a cationic urethane resin.

Since interfacial peeling between the pigment and the fabric is suppressed and the adhesive strength at the interface is further improved by using a cationic urethane resin, a printed material with more excellent wet rub fastness and color developability tends to be obtained. Further, the clogging properties also tend to be more excellent. Further, the cationic urethane resin has relatively high hardness, and thus tends to have degraded texture when extremely applied. Such a cationic urethane resin can be appropriately applied to a fabric by jetting the cationic urethane resin using an ink jet method and making the cationic urethane resin adhere to the fabric. Therefore, according to the present embodiment, degradation of the texture can also be suppressed. The cationic urethane resin can be used alone or in combination of two or more kinds thereof.

The cationic urethane resin is not particularly limited as long as the cationic urethane resin is a urethane resin that is soluble in water and positively charged in water. Examples of such a cationic urethane resin include a resin containing a cationic group in a molecule and formed of an aqueous dispersion obtained by self-emulsifying a urethane resin in an aqueous solvent. Examples of the cationic group include a quaternary ammonium group.

The cationic urethane resin which is an aqueous dispersion may be any of crosslinkable or non-crosslinkable. It is preferable that the cationic urethane resin be crosslinkable. In this manner, since interfacial peeling between the pigment and the fabric is further suppressed and the adhesive strength at the interface is further improved, a printed material with more excellent wet rub fastness and color developability can be obtained, and accordingly, the clogging properties tend to be more excellent.

It is preferable that the crosslinkable cationic urethane resin be obtained by emulsifying, in an aqueous solvent, a urethane resin containing an isocyanate group blocked with a blocking agent. The crosslinkable cationic urethane resin is further classified into a self-emulsifying type resin and a forced emulsifying type resin. It is preferable that the self-emulsifying type crosslinkable cationic urethane resin be obtained by self-emulsifying, in an aqueous solvent, the urethane resin in which an isocyanate group is blocked with a hydrophilic blocking agent. It is preferable that the forced emulsifying type crosslinkable cationic urethane resin be obtained by forcibly emulsifying, in an aqueous solvent using a surfactant or the like, a urethane resin containing an isocyanate group blocked with a hydrophobic blocking agent.

It is preferable that the non-crosslinkable cationic urethane resin be obtained by emulsifying a urethane resin containing no isocyanate group in an aqueous solvent.

The urethane resin is obtained by carrying out an addition polymerization reaction between a polyisocyanate and a polyol. Examples of the cationic urethane resin include a cationic ether-based urethane resin obtained by using a polyether-based polyol as a polyol, a cationic ester-based urethane resin obtained by using a polyester-based polyol as a polyol, and a cationic carbonate-based urethane resin obtained by using a polycarbonate-based polyol. Since the interfacial peeling between the pigment and the fabric is further suppressed and the adhesive strength at the interface is further improved, a printed material with more excellent wet rub fastness and color developability tends to be obtained, and the clogging properties tend to be more excellent, and from this viewpoint, it is preferable that the reaction solution composition contain a cationic ester-based urethane resin as the cationic urethane resin. Further, when polyester is used as a fabric, since the cationic ester-based urethane resin has an affinity for polyester fibers, a printed material with more excellent wet rub fastness and color developability tends to be obtained. From the viewpoint that polyester has an affinity for the cationic ester-based urethane resin and a printed material with more excellent wet rub fastness and color developability tends to be obtained, it is preferable that the cationic ester-based urethane resin contain polyester.

A commercially available product can be used as the cationic urethane resin, and examples thereof include HYDRAN (registered trademark) CP-7010, CP-7020, CP-7030, CP-7040, CP-7050, CP-7060, and CP-7610 (all trade names, manufactured by Dainippon Ink and Chemicals, Inc.), SUPERFLEX (registered trademark) 600, 610, 620, 630, 640, and 650 (all trade names, manufactured by DKS Co., Ltd.), and Urethane Emulsion WBR-2120C and WBR-2122C (both trade names, manufactured by Taisei Fine Chemical Co., Ltd.).

The content of the cationic urethane resin is preferably 1.5% by mass or greater and 8.0% by mass or less, more preferably 2.0% by mass or greater and 6.0% by mass or less, and still more preferably 3.0% by mass or greater and 5.0% by mass or less with respect to the total amount of the reaction solution composition. When the content of the cationic urethane resin is in the above-described ranges, the interfacial peeling between the pigment and the fabric is further suppressed, and the adhesive strength at the interface is further improved. As a result, a printed material with more excellent wet rub fastness and color developability tends to be obtained, and the clogging properties tend to be more excellent.

### 1.2. Water-Soluble Organic Solvent

The reaction solution composition contains a water-soluble organic solvent.

The water-soluble organic solvent has a function of relaxing a water absorption behavior of a fabric, a function of improving the wettability of the ink composition to a fabric, a function of enhancing moisture retaining properties of the ink composition, and the like. Further, when the reaction solution composition contains the water-soluble organic solvent, a printed material with more excellent wet rub fastness and color developability tends to be obtained, and the clogging properties tend to be more excellent. The water-soluble organic solvent can be used alone or in combination of two or more kinds thereof.

Examples of the water-soluble organic solvent include water-soluble esters, water-soluble alkylene glycol ethers, water-soluble cyclic esters, water-soluble nitrogen-containing solvents, and water-soluble alcohol. Examples of the nitrogen-containing solvent include water-soluble cyclic amides and water-soluble acyclic amides. Examples of the acyclic amides include water-soluble alkoxyalkylamides.

Examples of the esters include glycol monoacetates such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxy butyl acetate, and glycol diesters such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, diethylene glycol acetate butyrate, propylene glycol acetate propionate, propylene glycol acetate butyrate, dipropylene glycol acetate butyrate, and dipropylene glycol acetate propionate.

Examples of the alkylene glycol ethers include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether, and alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Examples of the cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and ε-decalactone, and a compound in which hydrogen of a methylene group adjacent to a carbonyl group thereof has been substituted with an alkyl group having 1 or more and 4 or less carbon atoms.

Examples of the alkoxyalkylamides include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, and 3-tert-butoxy-N,N-methylethylpropionamide.

Examples of the cyclic amides include lactams, and more specific examples thereof include pyrrolidones such as 2-pyrrolidone, 1-methyl-2-pyrrolidone, 1-ethyl-2-pyrrolidone, 1-propyl-2-pyrrolidone, and 1-butyl-2-pyrrolidone.

Examples of the alcohol include methanol, ethanol, n-propyl alcohol, iso-propyl alcohol, n-butanol, 2-butanol, tert-butanol, iso-butanol, n-pentanol, 2-pentanol, 3-pentanol, tert-pentanol, ethylene glycol, propylene glycol, 1,2-butanediol, 1,2-pentanediol, 1,2-hexanediol, 1,2-heptanediol, 1,2-octanediol, diethylene glycol, dipropylene glycol, triethylene glycol, 1,3-propanediol, 1,3-butanediol, 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 2-methyl-1,3-pentanediol, 3-methyl-1,5-pentanediol, 2-methylpentane-2,4-diol, trimethylolpropane, and glycerin.

It is preferable that the water-soluble organic solvent include a water-soluble organic solvent having a boiling point of 260° C. or higher. Further, in the present specification, the boiling point denotes a boiling point at a standard atmospheric pressure of 1013.25 hPa, that is, a standard boiling point (hereinafter, also referred to as “b.p.”).

In the present embodiment, when the water-soluble organic solvent having a boiling point of 260° C. or higher is used, the water-absorption behavior of a fabric can be further relaxed, the wettability of the ink composition to a fabric can be further improved, the moisture retention properties of the ink composition can be further enhanced, and the clogging properties tend to be more excellent.

Examples of the water-soluble organic solvent having a boiling point of 260° C. or higher include glycerin (boiling point: 290° C.), triethylene glycol (boiling point: 287° C.), triethylene glycol monobutyl ether (boiling point: 278° C.), tetraethylene glycol monobutyl ether (boiling point: 278° C.), and 1,6-hexanediol (boiling point: 338° C.).

The reaction solution composition contains, as the water-soluble organic solvent, preferably one or more selected from the group consisting of glycerin, propylene glycol, and triethylene glycol and more preferably one or more selected from the group consisting of glycerin and triethylene glycol. In this manner, the water absorption behavior of a fabric can be further relaxed, the wettability of the ink composition to a fabric can be further improved, the moisture retention properties of the ink composition can be further enhanced, and the clogging properties tend to be more excellent.

The content of the water-soluble organic solvent is preferably 1% by mass or greater and 50% by mass or less, more preferably 3% by mass or greater and 40% by mass or less, and still more preferably 5% by mass or greater and 30% by mass or less with respect to the total amount of the reaction solution composition. When the content of the water-soluble organic solvent is in the above-described ranges, the water absorption behavior of a fabric can be further relaxed, the wettability of the ink composition to a fabric can be further improved, the moisture retention properties of the ink composition can be further enhanced, and the clogging properties tend to be more excellent.

### 1.3. Water

The reaction solution composition contains water.

Examples of water include pure water such as ion exchange water, ultrafiltration water, reverse osmosis water, or distilled water, and ultrapure water obtained by removing ionic impurities as much as possible. Further, water sterilized by irradiation with ultraviolet rays, addition of hydrogen peroxide, and the like is preferable from the viewpoint of suppressing generation of mold and bacteria when the reaction solution composition is stored for a long period of time.

The content of water is preferably 40% by mass or greater and 85% by mass or less with respect to the total amount of the reaction solution composition. When the content of water is in the above-described range, an increase of the viscosity of the reaction solution composition can be suppressed.

### 1.4. Polyvalent Metal Salt

It is preferable that the reaction solution composition further contain a polyvalent metal salt.

The polyvalent metal salt is a compound formed of di- or higher valent metal ions and anions. The polyvalent metal salt has a function of aggregating components such as the pigment and the resin particles contained in the ink composition. Therefore, when the reaction solution composition contains the polyvalent metal salt, a printed material with more excellent color developability and wet rub fastness tends to be obtained. The degree of aggregation of the pigment and the resin particles caused by the polyvalent metal salt varies depending on the kinds of the polyvalent metal salt, the pigment, and the resin particles and can be adjusted. The polyvalent metal salt can be used alone or in combination of two or more kinds thereof.

Examples of the di- or higher valent metal ions contained in the polyvalent metal salt include ions of calcium, magnesium, copper, nickel, zinc, barium, aluminum, titanium, strontium, chromium, cobalt, and iron. Among these metal ions constituting the polyvalent metal salt, at least one of a calcium ion or a magnesium ion is preferable from the viewpoint that the aggregating properties of the components of the ink are excellent.

Examples of the anions constituting the polyvalent metal salt include inorganic ions and organic ions. That is, the polyvalent metal salt is formed of inorganic ions or organic ions and di- or higher valent metal ions. Examples of the inorganic ions include chlorine ions, bromine ions, iodine ions, nitrate ions, sulfate ions, and hydroxide ions. Examples of the organic ions include organic acid ions, and more specific examples thereof include carboxylate ions.

Specific examples of the polyvalent metal salt include calcium carbonate such as heavy calcium carbonate or light calcium carbonate, calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium acetate, magnesium acetate, and aluminum acetate. These polyvalent metal salts may be used alone or in combination of two or more kinds thereof. Among these, from the viewpoint that a printed material with more excellent color developability and wet rub fastness can be obtained, the solubility in water can be sufficiently ensured, and the amount of traces caused by the reaction solution composition is decreased, the polyvalent metal salt contains preferably one or more selected from the group consisting of magnesium sulfate, calcium nitrate, and calcium chloride and more preferably magnesium sulfate. Further, these metal salts may contain hydrated water in the raw material form.

The content of the polyvalent metal salt is preferably 0.01% by mass or greater and 10% by mass or less, more preferably 0.05% by mass or greater and 5.0% by mass or less, and still more preferably 1.0% by mass or greater and 2.4% by mass or less with respect to the total amount of the reaction solution composition. When the content of the polyvalent metal salt is in the above-described ranges, a printed material with more excellent color developability and wet rub fastness tends to be obtained.

### 1.5. Surfactant

The reaction solution composition may contain a surfactant.

The surfactant has a function of reducing the surface tension of the reaction solution composition to adjust the wettability to a recording medium. Examples of the surfactant include an acetylene glycol-based surfactant, a silicone-based surfactant, and a fluorine-based surfactant. The surfactant can be used alone or in combination of two or more kinds thereof.

From the viewpoint that a printed material with more excellent wet rub fastness and color developability can be obtained and the clogging properties are more excellent, it is preferable that the surfactant contain an acetylene glycol-based surfactant.

Examples of the acetylene glycol-based surfactant include SURFYNOL (registered trademark) 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (manufactured by Nissin Chemical Co., Ltd.), OLFINE (registered trademark) B, Y, P, A, STG, SPC, E1004, E1010, PD-001, PD-002W, PD-003, PD-004, EXP.4001, EXP.4036, EXP.4051, AF-103, AF-104, AK-02, and SK-14, AE-3 (manufactured by Nissin Chemical Co., Ltd.), and ACETYLENOL (registered trademark) E00, E0OP, E40, and E100 (manufactured by Kawaken Fine Chemicals Co., Ltd.).

Examples of the silicone-based surfactant include a polysiloxane-based compound such as a polyether-modified organosiloxane. Examples of a commercially available product of the polyether-modified organosiloxane include BYK-306, BYK-307, BYK-333, BYK-341, BYK-345, BYK-346, and BYK-348 (manufactured by BYK-Chemie GmbH), and KF-351A, KF-352A, KF-353, KF-354L, KF-355A, KF-615A, KF-945, KF-640, KF-642, KF-643, KF-6004, KF-6020, X-22-4515, KF-6011, KF-6012, KF-6015, and KF-6017 (manufactured by Shin-Etsu Chemical Co., Ltd.).

Examples of the fluorine-based surfactant include a fluorine-modified polymer, and examples of a commercially available product thereof include BYK-340 (manufactured by BYK-Chemie GmbH).

The content of the surfactant is preferably 0.01% by mass or greater and 10% by mass or less, more preferably 0.05% by mass or greater and 5.0% by mass or less, and still more preferably 0.1% by mass or greater and 1.0% by mass or less with respect to the total amount of the reaction solution composition. When the content of the surfactant is in the above-described ranges, a printed material with more excellent wet rub fastness and color developability tends to be obtained, and the clogging properties tend to be more excellent.

### 1.6. Other Components

The reaction solution composition may contain, for example, various additives such as a dissolution assistant, a viscosity adjuster, a pH adjuster, an antioxidant, an ultraviolet absorbing agent, an oxygen absorbing agent, a rust inhibitor, a corrosion inhibitor, and a chelating agent. The additives can be used alone or in combination of two or more kinds thereof.

The total content of the additives is preferably 0.01% by mass or greater and 10% by mass or less with respect to the total amount of the reaction solution composition. When the content of the additives is in the above-described range, a printed material with more excellent wet rub fastness and color developability tends to be obtained, and the clogging properties tend to be more excellent.

### 1.7. Method of Preparing Reaction Solution Composition

The reaction solution composition can be prepared by mixing respective components in any order and filtering the mixture as necessary to remove impurities, foreign matter, and the like. A method of sequentially adding respective components to a container provided with a stirring device such as a mechanical stirrer or a magnetic stirrer and stirring and mixing the mixture is used as a method of mixing the respective components. Examples of the filtration method include centrifugal filtration and filter filtration.

### 1.8. Physical Properties of Reaction Solution Composition

The physical properties of the reaction solution composition are optionally adjusted depending on the kind of fabric and a method of making the reaction solution composition adhere to a fabric, that is, a coating method. The coating method of the reaction solution composition will be described below.

### 1.8.1. Viscosity

The viscosity of the reaction solution composition at 20° C. is preferably set to 1.5 mPa·s or greater and 100 mPa·s or less. When the viscosity of the reaction solution composition is set to be in the above-described range, the coating properties such as ease of spreading of the reaction solution composition when adhering to a fabric can be improved.

Further, in the present specification, the viscosity is measured by using, for example, a viscoelasticity tester MCR-300 (manufactured by Physica). Specifically, the viscosity can be measured by adjusting the temperature of an object to be measured such as the reaction solution composition to 20° C. and reading the shear viscosity (mPa·s) at a shear rate of 200 (1/s).

### 1.8.2. Surface Tension

The surface tension of the reaction solution composition at 25° C. is preferably 30 mN/m or greater and 50 mN/m or less. When the surface tension of the reaction solution composition at 25° C. is set to be in the above-described range, appropriate wettability and permeability to a fabric are exhibited. Further, since the reaction solution composition is easily uniformly absorbed by a fabric, a difference in shades based on the adhesion amount that occurs when the reaction solution composition is applied, that is, occurrence of coating unevenness can be suppressed.

Further, in the present specification, the surface tension can be measured by using, for example, an automatic surface tension meter CBVP-Z (manufactured by Kyowa Interface Science Co., Ltd.). Specifically, the surface tension can be measured by reading the surface tension when a platinum plate is wet with an object to be measured such as the reaction solution composition in an environment of 25° C.

### 2. Ink Composition

The ink composition according to the present embodiment contains a pigment, a crosslinkable urethane resin, and water and is used to be jetted by an ink jet method and made to adhere to a fabric. The ink composition may be used to adhere to a fabric together with the reaction solution composition, but it is preferable that the ink composition be used to produce a printed material by performing textile printing on the fabric to which at least the reaction solution composition is adhered. From the viewpoint that a printed material with more excellent wet rub fastness and color developability tends to be obtained and the clogging properties tend to be more excellent, a fabric to which at least the reaction solution composition is adhered is preferable as the fabric on which the ink composition is textile-printed.

### 2.1. Pigment

The ink composition contains a pigment.

Examples of the pigment include a white pigment, an azo pigment such as an insoluble azo pigment, a condensed azo pigment, Azo Lake, or a chelate azo pigment, a polycyclic pigment such as a phthalocyanine pigment, a perylene pigment, a perinone pigment, an anthraquinone pigment, a quinacridone pigment, a dioxane pigment, a thioindigo pigment, an isoindolinone pigment, or a quinophthalone pigment, a dye chelate, a dye lake, a nitro pigment, a nitroso pigment, aniline black, a daylight fluorescent pigment, and carbon black. The pigment can be used alone or in combination of two or more kinds thereof.

Specific examples of the pigment include the followings.

Examples of the white pigment include a metal compound such as a metal oxide, barium sulfate, or calcium carbonate. Examples of the metal oxide include titanium dioxide, zinc oxide, silica, alumina, and magnesium oxide. Further, particles having a hollow structure may be used as the white pigment, and known particles can be used as such particles having a hallow structure.

Typical examples of the white pigment include titanium dioxide, and examples thereof include TIPAQUE CR-50-2, CR-57, CR-58-2, CR-60-2, CR-60-3, CR-Super-70, CR-90-2, CR-95, CR953, PC-3, PF-690, PF-691, PF-699, PF-711, PF-728, PF-736, PF-737, PF-739, PF-740, PF-742, R-980, and UT-771 (all manufactured by Ishihara Sangyo Kaisha, Ltd.), and C.I. Pigment White 6.

Examples of a black pigment include No. 2300, 900, MCF88, No. 20B, No. 33, No. 40, No. 45, No. 52, MA7, MA8, MA100, and No. 2200B (all manufactured by Mitsubishi Chemical Corporation), Carbon Black FW1, FW2, FW2V, FW18, FW200, S150, S160, S170, PRINTEX (registered trademark) 35, U, V, 140U, Special Black 6, 5, 4A, 4, and 250 (all manufactured by Degussa-Huls AG), CONDUCTEX (registered trademark) SC, RAVEN (registered trademark) 1255, 5750, 5250, 5000, 3500, 1255, and 700 (all manufactured by Columbia Carbon), REGAL (registered trademark) 400R, 330R, 660R, MOGUL L, MONARCH 700, 800, 880, 900, 1000, 1100, 1300, 1400, and ELFTEX 12 (all manufactured by Cabot Corporation), and MICROJET (registered trademark) CW-1, CW-1S, CW-2, CW-3, and M-800 (all manufactured by Orient Chemical Industries Co., Ltd.).

Examples of a yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of a magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224, and 245, C.I. Pigment Violet 19, 23, 32, 33, 36, 38, 43, and 50.

Examples of a cyan pigment include C.I. Pigment Blue 1, 2, 3, 15, 15:1, 15:2, 15:3, 15:34, 15:4, 16, 18, 22, 25, 60, 65, and 66, and C.I. Vat Blue 4 and 60.

Further, examples of pigments other than the magenta, cyan, and yellow pigments include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

Further, examples of a pearl pigment include pigments having pearl gloss or interference gloss, such as titanium dioxide-coated mica, fish scale flake, and bismuth oxychloride.

Examples of a metallic pigment include particles formed of a single metal such as aluminum, silver, gold, platinum, nickel, chromium, tin, zinc, indium, titanium, or copper or an alloy thereof.

From the viewpoint that a printed material with more excellent wet rub fastness and color developability tends to be obtained and the clogging properties tend to be more excellent, the content of the pigment is preferably 1% by mass or greater and 10% by mass or less with respect to the total amount of the ink composition.

It is suitable that the pigment can be stably dispersed or dissolved in a dispersion medium, and the pigment may be dispersed in a dispersion medium by using a dispersant as necessary. Examples of such a dispersant include a resin dispersant, and the dispersant is selected from those that are capable of enhancing the dispersion stability of the pigment in the ink composition. Further, the pigment may be used as a self-dispersing pigment, for example, by oxidizing or sulfonating the surface of the pigment with ozone, hypochlorous acid, fuming sulfuric acid, or the like to modify the surface of the pigment particles.

Examples of the resin dispersant include water-soluble resins, for example, a (meth)acrylic resin such as poly(meth)acrylic acid, a (meth)acrylic acid-acrylonitrile copolymer, a (meth)acrylic acid-(meth)acrylic acid ester copolymer, a vinyl acetate-(meth)acrylic acid ester copolymer, a vinyl acetate-(meth)acrylic acid copolymer, or a vinylnaphthalene-(meth)acrylic acid copolymer and salts thereof, a styrene-based resin such as a styrene-(meth)acrylic acid copolymer, a styrene-(meth)acrylic acid-(meth)acrylic acid ester copolymer, a styrene-α-methylstyrene-(meth)acrylic acid copolymer, a styrene-α-methylstyrene-(meth)acrylic acid-(meth)acrylic acid ester copolymer, a styrene-maleic acid copolymer, or a styrene-maleic anhydride copolymer and salts thereof, a urethane-based resin which is a polymer compound (resin) obtained by reacting an isocyanate group and a hydroxyl group and having a urethane bond, may be linear and/or branched, and may or may not have a crosslinked structure, polyvinyl alcohols, a vinylnaphthalene-maleic acid copolymer and a salt thereof, a vinyl acetate-maleic acid ester copolymer and a salt thereof, and a vinyl acetate-crotonic acid copolymer and a salt thereof. Among these, a copolymer of a monomer containing a hydrophobic functional group and a monomer containing a hydrophilic functional group or a polymer formed of a monomer containing both of a hydrophobic functional group and a hydrophilic functional group is preferable. The copolymer can be used in any form such as a random copolymer, a block copolymer, an alternating copolymer, or a graft copolymer. The resin dispersant can be used alone or in combination of two or more kinds thereof.

Examples of a commercially available product of the styrene-based resin dispersant include X-200, X-1, X-205, X-220, and X-228 (manufactured by Seiko PMC Corporation), NOPCOSPERSE (registered trademark) 6100 and 6110 (manufactured by San Nopco Limited), JONCRYL (registered trademark) 67, 586, 611, 678, 680, 682, and 819 (manufactured by BASF SE), DISPERBYK (registered trademark)-190 (manufactured by BYK-Chemie GmbH), N-EA137, N-EA157, N-EA167, N-EA177, N-EA197D, N-EA207D, and E-EN10 (manufactured by DKS Co., Ltd.).

Examples of a commercially available product of the acrylic resin dispersant include DISPERBYK-187, BYK-190, BYK-191, BYK-194N, BYK-199 (manufactured by BYK-Chemie GmbH), and ARON (registered trademark) A-210, A6114, AS-1100, AS-1800, A-30SL, A-7250, and CL-2 (manufactured by Toagosei Co., Ltd.).

Examples of a commercially available product of the urethane-based resin dispersant include DISPERBYK-182, BYK-183, BYK-184, and BYK-185 (manufactured by BYK-Chemie GmbH), TEGO (registered trademark) Disperse 710 (manufactured by Evonik Tego Chemie GmbH), and Borchi (registered trademark) Gen 1350 (manufactured by OMG Borchers GmbH).

Further, the examples of the commercially available products have been described, but the dispersant may be obtained by synthesis using a method of the related art.

The total content of the resin dispersant in the ink composition is preferably 0.1 parts by mass or greater and 30 parts by mass or less with respect to 100 parts by mass of the pigment.

### 2.2. Crosslinkable Urethane Resin

The ink composition contains a crosslinkable urethane resin.

When a crosslinkable urethane resin is used, since interfacial peeling between the pigment and the fabric is suppressed and the adhesive strength at the interface is further improved, a printed material with more excellent wet rub fastness and color developability tends to be obtained. Further, the clogging properties also tend to be more excellent. Further, the crosslinkable urethane resin is capable of further improving the adhesiveness or the like of the image formed by the ink composition adhered to a recording medium. The crosslinkable urethane resin can be used alone or in combination of two or more kinds thereof.

The crosslinkable urethane resin is not particularly limited as long as the urethane resin is soluble in water and contains a crosslinkable group. Examples of such a crosslinkable urethane resin include a resin containing a crosslinkable group in a molecule and formed of an aqueous dispersion obtained by self-emulsifying a urethane resin in an aqueous solvent.

Examples of the crosslinkable group include an isocyanate group and a silanol group. It is preferable to use, as the isocyanate group, a blocked isocyanate group which has been chemically protected, that is, capped or blocked. The blocked isocyanate group is deprotected and activated by application of heat so that a bond, for example, a urethane bond, a urea bond, or an allophanate bond is formed. It is preferable that three or more crosslinkable groups be provided in one molecule, and a crosslinked structure is formed by the reaction between the crosslinkable groups in such a case.

A blocked isocyanate contains a latent isocyanate group in which an isocyanate group is blocked by a blocking agent, and can be obtained by reacting a polyisocyanate compound with a blocking agent.

Examples of the polyisocyanate compound include a polyisocyanate monomer and a polyisocyanate derivative. Examples of the polyisocyanate monomer include a polyisocyanate such as an aromatic polyisocyanate, an aliphatic polyisocyanate, or an alicyclic polyisocyanate. These polyisocyanate monomers can be used alone or in combination of two or more kinds thereof.

Examples of the polyisocyanate derivative include a multimer and a dimer of the polyisocyanate monomer, a trimer, a pentamer, a heptamer, and the like of an isocyanurate-modified product, an iminooxadiazinedione-modified product, and the like, an allophanate-modified product such as an allophanate-modified product generated by the reaction between the polyisocyanate monomer described above and a low-molecular-weight polyol described below, a polyol-modified product such as a polyol-modified product generated by the reaction between a polyisocyanate monomer and a low-molecular-weight polyol described below, a biuret-modified product such as a biuret-modified product generated by the reaction between the polyisocyanate monomer, water, and amines, a urea-modified product such as a urea-modified product generated by the reaction between the polyisocyanate monomer and a diamine, an oxadiazinetrione-modified product such as an oxadiazinetrione generated by the reaction between the polyisocyanate monomer and carbon dioxide gas, a carbodiimide-modified product such as a carbodiimide-modified product generated by a decarboxylation condensation reaction of the polyisocyanate monomer, a uretdione-modified product, and a uretonimine-modified product.

Further, when the polyisocyanate compound is used in combination of two or more kinds thereof, for example, two or more kinds of polyisocyanate compounds may react with each other simultaneously or blocked isocyanates obtained by using each polyisocyanate compound individually may be mixed in the production of the blocked isocyanate.

The blocking agent blocks and deactivates the isocyanate group and also regenerates or activates the isocyanate group after deblocking the isocyanate group. Further, the blocking agent also has a catalytic action of activating the isocyanate group in a state where the isocyanate group is blocked or deblocked.

Examples of the blocking agent include an imidazole-based compound, an imidazoline-based compound, a pyrimidine-based compound, a guanidine-based compound, an alcohol-based compound, a phenol-based compound, an active methylene-based compound, an amine-based compound, an imine-based compound, an oxime-based compound, a carbamic acid-based compound, a urea-based compound, a lactam-based compound, an acid imide-based compound, a triazole-based compound, a pyrazole-based compound, a mercaptan-based compound, and a bisulfite.

Such a blocking agent can be used alone or in combination of two or more kinds thereof. The dissociation temperature of the blocking agent can be selected as appropriate. The dissociation temperature thereof is, for example, 60° C. or higher and 230° C. or lower, preferably 80° C. or higher and 200° C. or lower, more preferably 100° C. or higher and 180° C. or lower, and still more preferably 110° C. or higher and 160° C. or lower. In a case where the dissociation temperature thereof is in the above-described ranges, the pot life of the ink jet ink composition can be made sufficiently long, and the temperature is prevented from being extremely high when the ink jet ink composition is heated.

The main chain of the crosslinkable urethane resin may be any of a polyether type having an ether bond, a polyester type having an ester bond, a polycarbonate type having a carbonate bond, or the like. The elongation at break and the 100% modulus when the crosslinkable urethane resin is crosslinked to form a crosslinked product can be adjusted by changing the density of the crosslinking point and the kind of such a main chain. Among the examples, a crosslinkable urethane resin having a polycarbonate-based skeleton or a polyether-based skeleton is preferable. These crosslinkable urethane resins are well-balanced between the elongation at break and the 100% modulus, and thus a printed material with more excellent wet rub fastness and color developability tends to be obtained, and the clogging properties also tend to be more excellent.

The average particle diameter of the crosslinkable urethane resin is preferably 20 nm or greater and 300 nm or less. When a crosslinkable urethane resin having such an average particle diameter is used, a printed material with more excellent wet rub fastness and color developability tends to be obtained and the clogging properties also tend to be more excellent.

Examples of a commercially available product of the crosslinkable urethane resin include TAKELAC (registered trademark) WS-6021 (trade name, manufactured by Mitsui Chemicals Inc., urethane-based resin emulsion, polyether-based polyurethane having polyether-derived skeleton), WS-5100 (trade name, manufactured by Mitsui Chemicals Inc., urethane-based resin emulsion, polycarbonate-based polyurethane having polycarbonate-derived skeleton), ELASTRON (registered trademark) E-37 and H-3 (both polyester-based polyurethanes in which main chain has polyester-derived skeleton), ELASTRON (registered trademark) H-38, BAP, C-52, F-29, and W-11P (all polyether-based polyurethanes in which main chain has polyether-derived skeleton) (all trade names, manufactured by DKS Co., Ltd., urethane-based resin emulsion), SUPERFLEX (registered trademark) 870, 800, 150, 420, 460, 470, 610, and 700 (all trade names, manufactured by DKS Co., Ltd., urethane-based resin emulsion), PERMARIN (registered trademark) UA-150 (trade name, manufactured by Sanyo Chemical Industries, Ltd., urethane-based resin emulsion), SANCURE (registered trademark) 2710 (trade name, manufactured by The Lubrizol Corporation, urethane-based resin emulsion), NeoRez (registered trademark) R-9660, R-9637, and R-940 (all trade names, manufactured by Kusumoto Chemicals Ltd., urethane-based resin emulsion), ADEKA BONTIGHTER (registered trademark) HUX-380 and 290K (both trade names, manufactured by ADEKA Corporation, urethane-based resin emulsion), ETERNACALL (registered trademark) UW-1501F, UW-1527DF, UW-1614AF, and UW-2201AF (all trade names, manufactured by UBE Corporation, urethane-based resin emulsion).

The content of the crosslinkable urethane resin is preferably 1.0% by mass or greater and 10.0% by mass or less, more preferably 2.0% by mass or greater and 8.0% by mass or less, and still more preferably 3.0% by mass or greater and 7.0% by mass or less with respect to the total amount of the ink composition. When the content of the crosslinkable urethane resin is in the above-described ranges, the interfacial peeling between the pigment and the fabric is further suppressed, and the adhesive strength at the interface is further improved. Therefore, a printed material with more excellent wet rub fastness and color developability tends to be obtained, and the clogging properties tend to be more excellent.

### 2.3. Water

The ink composition contains water. The water may refer to the water contained in the reaction solution composition.

The content of water is preferably 45% by mass or greater, more preferably 50% by mass or greater and 98% by mass or less, and still more preferably 55% by mass or greater and 95% by mass or less with respect to the total amount of the ink composition.

### 2.4. Water-Soluble Organic Solvent

The ink composition may contain a water-soluble organic solvent. The water-soluble organic solvent may refer to the water-soluble organic solvent contained in the reaction solution composition. The water-soluble organic solvent can be used alone or in combination of two or more kinds thereof.

From the viewpoint that a printed material with more excellent wet rub fastness and color developability tends to be obtained and the clogging properties tend to be more excellent, it is preferable that the ink composition contain one or more selected from the group consisting of glycerin and triethylene glycol as the water-soluble organic solvent.

The content of the water-soluble organic solvent is preferably 1% by mass or greater and 30% by mass or less, more preferably 3% by mass or greater and 25% by mass or less, and still more preferably 5% by mass or greater and 20% by mass or less with respect to the total amount of the ink composition. When the content of the water-soluble organic solvent is in the above-described ranges, a printed material with more excellent wet rub fastness and color developability tends to be obtained, and the clogging properties tend to be more excellent.

### 2.5. Surfactant

The ink composition may contain a surfactant. The surfactant may refer to the surfactant contained in the reaction solution composition. The surfactant can be used alone or in combination of two or more kinds thereof.

From the viewpoint that a printed material with more excellent wet rub fastness and color developability tends to be obtained and the clogging properties tend to be more excellent, it is preferable that the ink composition contain an acetylene glycol-based surfactant as the surfactant.

The content of the surfactant is preferably 0.01% by mass or greater and 10% by mass or less, more preferably 0.05% by mass or greater and 5.0% by mass or less, and still more preferably 0.1% by mass or greater and 1.0% by mass or less with respect to the total amount of the ink composition. When the content of the surfactant is in the above-described ranges, a printed material with more excellent wet rub fastness and color developability tends to be obtained, and the clogging properties tend to be more excellent.

### 2.6. pH Adjuster

The ink composition may contain a pH adjuster. When the ink composition contains a pH adjuster, the storage stability of the ink composition tends to be further improved. The pH adjuster can be used alone or in combination of two or more kinds thereof.

Examples of the pH adjuster include appropriate combinations of acids, bases, weak acids, and weak bases. As the acids and the bases used in such combinations, examples of inorganic acids include sulfuric acid, hydrochloric acid, and nitric acid, examples of inorganic bases include lithium hydroxide, sodium hydroxide, potassium hydroxide, potassium dihydrogen phosphate, disodium hydrogen phosphate, potassium carbonate, sodium carbonate, sodium hydrogen carbonate, and ammonia, examples of organic bases include triethanolamine, diethanolamine, monoethanolamine, tripropanolamine, triisopropanolamine, diisopropanolamine, and trishydroxymethylaminomethane (THAM), and examples of organic acids include adipic acid, citric acid, succinic acid, lactic acid, good buffers such as N,N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), morpholinopropanesulfonic acid (MOPS), carbamoylmethyliminobisacetic acid (ADA), piperazine-1,4-bis(2-ethanesulfonic acid) (PIPES), N-(2-acetamido)-2-aminoethanesulfonic acid (ACES), cholamine chloride, N-tris(hydroxymethyl)methyl-2-aminoethanesulfonic acid (TES), acetamidoglycine, tricine, glycinamide, and bicine, a phosphate buffer solution, a citrate buffer solution, and a tris buffer solution. Further, the ink composition may contain a tertiary amine such as triethanolamine or triisopropanolamine, and a carboxyl group-containing organic acid such as adipic acid, citric acid, succinic acid, or lactic acid as a part or the entirety of the pH adjuster from the viewpoint of more stably obtaining a pH buffering effect.

The content of the pH adjuster is preferably 1.0% by mass or less and more preferably 0.05% by mass or greater and 0.5% by mass or less with respect to the total amount of the ink composition. When the content of the pH adjuster is in the above-described ranges, the storage stability of the ink composition tends to be further improved.

### 2.7. Other Components

The ink composition may contain various additives such as a dissolution assistant, a viscosity adjuster, an antioxidant, an ultraviolet absorbing agent, an oxygen absorbing agent, a rust inhibitor, a corrosion inhibitor, and a chelating agent. The additives can be used alone or in combination of two or more kinds thereof.

The total content of the additives is preferably 0.01% by mass or greater and 10% by mass or less with respect to the total amount of the ink composition. When the content of the additives is in the above-described range, a printed material with more excellent wet rub fastness and color developability tends to be obtained, and the clogging properties tend to be more excellent.

### 2.8. Method of Preparing Ink Composition

The ink composition can be prepared by mixing the components in any order and filtering the mixture as necessary to remove impurities or foreign matter. The method of mixing the components may refer to the method of preparing the reaction solution composition described above.

### 2.9. Viscosity of Ink Composition

The viscosity of the ink composition at 20° C. is preferably 1.5 mPa·s or greater and 15 mPa·s or less, more preferably 1.5 mPa·s or greater and 7 mPa·s or less, and still more preferably 1.5 mPa·s or greater and 5.5 mPa·s or less.

### 2.10. Surface Tension of Ink Composition

From the viewpoint of making the wet spreadability to a recording medium appropriate, the surface tension of the ink composition at 25° C. is preferably 15 mN/m or greater and 40 mN/m or less and more preferably 20 mN/m or greater and 35 mN/m or less. When the surface tension of the ink composition is in the above-described ranges, the jetting stability and initial filling properties during ink jet recording can be further enhanced.

### 3. Post-Treatment Liquid Composition

A post-treatment liquid composition according to the present embodiment contains resin particles and water and is used to be jetted by an ink jet method to adhere to a fabric. It is preferable that the post-treatment liquid composition be used to adhere to a fabric to which at least the reaction solution composition and the ink composition are adhered.

### 3.1. Resin Particles

The resin particles can further improve the adhesiveness and the like of an image formed by the ink composition adhered to a fabric. Examples of the resin particles include resin particles containing a urethane-based resin, an acrylic resin (including a styrene-acrylic resin), a fluorene-based resin, a polyolefin-based resin, a rosin-modified resin, a terpene-based resin, a polyester-based resin, a polyamide-based resin, an epoxy-based resin, a vinyl chloride-based resin, a vinyl chloride-vinyl acetate copolymer, an ethylene vinyl acetate-based resin, and the like. Among these, one or more selected from the group consisting of a urethane-based resin, an acrylic resin, a polyolefin-based resin, and a polyester-based resin are preferable. These resin particles are handled in the form of an emulsion, that is, a resin dispersion in many cases, but may be supplied in a powder state. The resin particles can be used alone or in combination of two or more kinds thereof.

The urethane-based resin is not particularly limited as long as the resin has a urethane bond. Examples of such a resin include a polyether type urethane resin having an ether bond in the main chain together with a urethane bond, a polyester type urethane resin having an ester bond in the main chain together with a urethane bond, and a polycarbonate type urethane resin having a carbonate bond in the main chain together with a urethane bond.

The acrylic resin is a general term for polymers obtained by polymerizing at least an acrylic monomer such as (meth)acrylic acid or (meth)acrylic acid ester as one component. Examples of the acrylic resin include a resin obtained from an acrylic monomer and a copolymer of an acrylic monomer and a monomer other than the acrylic monomer. More specific examples thereof include an acryl-vinyl-based resin which is a copolymer of an acrylic monomer and a vinyl-based monomer. Further, examples of the vinyl-based monomer include styrene. In the present specification, the term (meth)acryl denotes at least one of acryl or methacryl.

For example, acrylamide, acrylonitrile, or the like can be used as the acrylic monomer. As a resin emulsion formed of an acrylic resin as a raw material, a commercially available product may be used, and examples thereof include FK-854 (trade name, manufactured by Chirika Co., Ltd.), MOVINYL (registered trademark) 952B and 718A (both trade names, manufactured by Nippon Synthetic Chemical Industry Co., Ltd.), and Nipol (registered trademark) LX852 and LX874 (both trade names, manufactured by Zeon Corporation).

The styrene-acrylic resin is a copolymer obtained from a styrene monomer and a (meth)acrylic monomer, and examples thereof include a styrene-acrylic copolymer, a styrene-methacrylic acid copolymer, a styrene-methacrylic acid-acrylic acid ester copolymer, a styrene-α-methylstyrene-acrylic acid copolymer, a styrene-α-methylstyrene-acrylic acid-acrylic acid ester copolymer. A commercially available product may be used as the styrene-acrylic resin, and examples thereof include JONCRYL (registered trademark) 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (all trade names, manufactured by BASF SE), MOVINYL (registered trademark) 966A and 975N (both trade names, manufactured by Nippon Synthetic Chemical Industry Co., Ltd.), and VINYBLAN (registered trademark) 2586 (trade name, manufactured by Nissin Chemical Co., Ltd.).

The polyolefin-based resin contains an olefin such as ethylene, propylene, or butylene in the structure skeleton, and can be appropriately selected from known resins and then used. A commercially available product can be used as the olefin resin, and examples thereof include ARROWBASE (registered trademark) CB-1200 and CD-1200 (both trade names, manufactured by Unitika Ltd.).

Examples of the polyester-based resin include a polycondensate of polyvalent carboxylic acid and polyhydric alcohol, and a ring-opening polycondensate of cyclic lactam. A commercially available product may be used as the polyester-based resin, and examples thereof include EX-200A, A-110F, A-160P, A-520, A-613D, A-615GE, A-640, A-645GH, and A-647GEX (all trade names, manufactured by Takamatsu oil & fat Co., Ltd.).

Further, the commercially available products have been described above, but the resin particles may be obtained by synthesis using a method of the related art.

The content of the resin particles is preferably 1.0% by mass or greater and 30.0% by mass or less, more preferably 3.0% by mass or greater and 15.0% by mass or less, and still more preferably 3.0% by mass or greater and 10.0% by mass or less with respect to the total amount of the post-treatment liquid composition. When the content of the resin particles is in the above-described ranges, a printed material with more excellent wet rub fastness and color developability tends to be obtained.

It is preferable that the post-treatment liquid composition according to the present embodiment contain particles containing an organopolysiloxane and water and be used to adhere to a fabric by being jetted using an ink jet method. Since water repellency can be imparted to the surface of the fibers in a fabric by using such a post-treatment liquid composition, swelling of the fibers and permeation of water into the interface between the pigment and the fabric tend to be suitably suppressed. Therefore, a printed material with more excellent wet rub fastness and color developability tends to be obtained. The particles containing an organopolysiloxane can be used alone or in combination of two or more kinds thereof.

### 3.2. Particles Containing Organopolysiloxane

The particles containing an organopolysiloxane are typically handled in the form of an emulsion, that is, a resin dispersion in many cases, but may be supplied in a powder state.

Examples of the organopolysiloxane include a linear or cyclic organopolysiloxane. Examples of the linear organopolysiloxane include a linear unmodified organopolysiloxane and a linear modified organopolysiloxane. The organopolysiloxane may be used alone or in combination of two or more kinds thereof.

Examples of the linear unmodified organopolysiloxane include dimethyl silicone, methyl phenyl silicone, and methyl hydrogen silicone.

Examples of the linear modified organopolysiloxane include those obtained by modifying the linear unmodified organopolysiloxane with alkyl, aralkyl, polyether, higher fatty acid ester, higher fatty acid amide, fluoroalkyl, amino, epoxy, carboxy, alcohol, phenyl, carbinol, methacryl, mercapto, silanol, acryl, or diol.

Examples of the cyclic organopolysiloxane include cyclic dimethylsiloxane such as hexamethyl cyclotrisiloxane, octamethyl cyclotetrasiloxane, and decamethyl cyclopentasiloxane.

Among these, a linear modified organopolysiloxane is preferable, and amino-modified silicone is more preferable. That is, it is more preferable that the particles containing an organopolysiloxane include particles containing amino-modified silicone.

The content of the organopolysiloxane is preferably in a range of 20.0% to 80.0% by mass and more preferably in a range of 30.0% to 70.0% by mass with respect to the total amount of the particles. When the content of the organopolysiloxane is in the above-described ranges, a printed material with more excellent wet rub fastness and color developability tends to be obtained.

Examples of a commercially available product of the particles containing an organopolysiloxane include POLON (registered trademark)-MF-14, POLON-MF-18T, POLON-MF-33, and KM-2002-T (all trade names, manufactured by Shin-Etsu Chemical Co., Ltd.), and HISOFTER (registered trademark) K-15, K-45, K-355, and KB-1000 (all trade names, manufactured by Meisei Chemical Works, Ltd.).

The content of the particles containing an organopolysiloxane is preferably 1.0% by mass or greater and 30.0% by mass or less, more preferably 3.0% by mass or greater and 20.0% by mass or less, and still more preferably 3.0% by mass or greater and 15.0% by mass or less with respect to the total amount of the post-treatment liquid composition. When the content of the particles containing an organopolysiloxane is in the above-described ranges, a printed material with more excellent wet rub fastness and color developability tends to be obtained.

### 3.3. Water

The post-treatment liquid composition contains water. The water may refer to the water contained in the reaction solution composition.

The content of water is preferably 45% by mass or greater, more preferably 50% by mass or greater and 98% by mass or less, and still more preferably 55% by mass or greater and 95% by mass or less with respect to the total amount of the post-treatment liquid composition.

### 3.4. Water-Soluble Organic Solvent

The post-treatment liquid composition may contain a water-soluble organic solvent. The water-soluble organic solvent may refer to the water-soluble organic solvent contained in the reaction solution composition described above. The water-soluble organic solvent can be used alone or in combination of two or more kinds thereof.

The content of the water-soluble organic solvent is preferably 1% by mass or greater and 30% by mass or less with respect to the total amount of the post-treatment liquid composition. When the content of the water-soluble organic solvent is in the above-described range, a printed material with more excellent wet rub fastness and color developability tends to be obtained.

### 3.5. Surfactant

The post-treatment liquid composition may contain a surfactant. The surfactant may refer to the surfactant contained in the reaction solution composition described above.

The content of the surfactant is preferably 0.01% by mass or greater and 10% by mass or less with respect to the total amount of the post-treatment liquid composition. The surfactant can be used alone or in combination of two or more kinds thereof. When the content of the surfactant is in the above-described range, a printed material with more excellent wet rub fastness and color developability tends to be obtained.

### 3.6. Other Components

The post-treatment liquid composition may contain, for example, various additives such as a dissolution assistant, a viscosity adjuster, an antioxidant, an ultraviolet absorbing agent, an oxygen absorbing agent, a rust inhibitor, a corrosion inhibitor, and a chelating agent. The additives can be used alone or in combination of two or more kinds thereof.

The total content of the additives is preferably 0.01% by mass or greater and 10% by mass or less with respect to the total amount of the post-treatment liquid composition. When the content of the other components is in the above-described range, a printed material with more excellent wet rub fastness and color developability tends to be obtained.

### 3.7. Method of Preparing Post-Treatment Liquid Composition

The post-treatment liquid composition can be prepared by mixing respective components in any order and filtering the mixture as necessary to remove impurities, foreign matter, and the like. The method of mixing the respective components may refer to the method of preparing the reaction solution composition described above.

### 3.8. Physical Properties of Post-Treatment Liquid Composition

The physical properties of the post-treatment liquid composition are optionally adjusted depending on the kind of the fabric, the kind of the reaction solution composition or the ink composition, and a method of making the composition adhere to a fabric, that is, a coating method. The coating method of the post-treatment liquid composition will be described below.

### 3.8.1. Viscosity of Post-Treatment Liquid Composition

The viscosity of the post-treatment liquid composition at 20° C. is preferably 1.5 mPa·s or greater and 15 mPa·s or less.

### 3.8.2. Surface Tension

The surface tension of the post-treatment liquid composition at 25° C. is preferably set to 30 mN/m or greater and 50 mN/m or less.

### 4. Fabric

Examples of the fabric according to the present embodiment include natural fibers such as cotton, hemp, wool, leather, and silk, synthetic fibers such as polypropylene, polyester, acetate, triacetate, polyamide, acryl, and polyurethane, and biodegradable fibers such as polylactic acid. Further, blended fibers thereof may be used as the fabric.

From the viewpoint of obtaining a printed material with more excellent wet rub fastness and color developability, it is preferable that the fabric include polyester.

Examples of the form of the fabric include woven fabrics, knitted fabrics, nonwoven fabrics, cloth, clothing, and other accessories. Examples of the clothing and other accessories include furniture such as T-shirts, handkerchiefs, scarves, towels, carrier bags, cloth bags, curtains, sheets, bed covers after sewing, and wallpaper, and cloth before and after cutting as a component before sewing. Examples of the form thereof include a long fabric wound into a roll, a fabric cut into a predetermined size, and a fabric formed into a product. Further, a fabric to which at least the reaction solution composition has been applied in advance may be used as the fabric.

The weight of the fabric per unit area is, for example, preferably 1.0 oz or greater and 10.0 oz or less. When the weight of the fabric per unit area is in the above-described range, recording can be satisfactorily performed.

A fabric colored with a dye in advance may be used as the fabric. Since the reaction solution composition is difficult to generate treatment traces, even a fabric colored in advance can be used. That is, textile printing in which generation of treatment traces is suppressed can be performed even when a fabric is colored, and thus the quality or the commercial value of a printed material as a product can be further increased as compared with those of the related art.

Examples of the dye that colors a fabric in advance include water-soluble dyes such as acid dyes and basic dyes, disperse dyes obtained by combining a dispersant, reactive dyes, and solvent dyes.

### 5. Ink Jet Recording Method

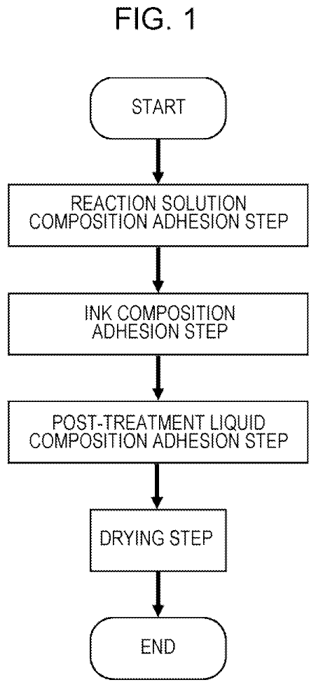

A recording method according to the present embodiment (hereinafter, also simply referred to as “recording method”) includes a reaction solution composition adhesion step of jetting the reaction solution composition included in the set according to the present embodiment from a recording head to make the reaction solution composition adhere to a fabric and an ink jet ink composition adhesion step (hereinafter, also referred to as “ink composition adhesion step”) of jetting the ink jet ink composition included in the set according to the present embodiment from the recording head to make the ink jet ink composition adhere to at least the fabric to which the reaction solution composition is adhered. According to such a recording method, a printed material with more excellent wet rub fastness and color developability is obtained. Further, the clogging properties tend to be more excellent. In the recording method, the amount of coating the fabric with the reaction solution composition and the ink composition can be appropriately adjusted, and thus the load of the steps can be reduced. The recording method can be applied to various fabrics, and textile printing can be satisfactorily performed. In the recording method, the reaction solution composition adhesion step may be performed simultaneously with the ink composition adhesion step. Further, FIG. 1 shows an example of the ink jet recording method according to the present embodiment. This ink jet recording method includes the reaction solution composition adhesion step, the ink composition adhesion step described above, a post-treatment liquid composition adhesion step, and a drying step described below in this order.

Next, each step will be described.

### 5.1. Reaction Solution Composition Adhesion Step

The ink jet recording method includes a reaction solution composition adhesion step of jetting the reaction solution composition from a recording head to make the reaction solution composition adhere to a fabric. The reaction solution composition adhesion step is performed simultaneously with or before the ink composition adhesion step.

A fabric to which the reaction solution composition is adhered is obtained by performing the present step. Further, a printed material with more excellent wet rub fastness and color developability is obtained by making the ink composition according to the present embodiment adhere to the fabric.

In the present embodiment, the ink jet method is used to make the reaction solution composition adhere to a fabric because the method increases the degree of freedom in designing the adhesion amount of the reaction solution composition, is difficult to cause problems during the adhesion, and enables uniform adhesion of the reaction solution composition to the fabric. Further, the reaction solution composition has excellent clogging properties, and thus adhesion can be stably continuously performed during the adhesion using the ink jet method.

The adhesion amount of the reaction solution composition to the fabric is preferably 20% by mass or greater and 80% by mass or less and more preferably 30% by mass or greater and 75% by mass or less with respect to the mass of a region of the fabric to which the reaction solution composition adheres. When the adhesion amount thereof is in the above-described ranges, since the reaction solution composition more suitably matches with the fabric and more uniformly adheres to the fabric, the fabric tends to suitably absorb water and be swollen. In this manner, a printed material with more excellent wet rub fastness and color developability tends to be obtained. Further, in the present specification, the adhesion amount of the reaction solution composition is expressed as a percentage of the mass which is the adhesion amount of the reaction solution composition to the mass of the region of the fabric to which the reaction solution composition is adhered.

After the present step, a drying step of drying the fabric to which the reaction solution composition is adhered may be performed as necessary. However, from the viewpoint that a printed material with more excellent wet rub fastness and color developability tends to be obtained, it is preferable that the drying step be not performed. Further, the drying method and the drying time in the drying step may refer to the heating method and the heating time in the ink composition adhesion step described below.

### 5.2. Ink Composition Adhesion Step

The ink jet recording method includes an ink composition adhesion step of jetting the ink composition from the recording head to make the ink composition repeatedly adhere to at least the region of the fabric to which the reaction solution composition is adhered. The ink composition adhesion step is performed simultaneously with or after the reaction solution composition adhesion step.

A fabric to which at least the reaction solution composition and the ink composition are adhered is obtained by performing the present step. Further, a printed material with more excellent wet rub fastness and color developability is obtained by making the ink composition according to the present embodiment adhere to the fabric.

The fabric used for adhesion in the present step may be a fabric to which at least the reaction solution composition is adhered, and for example, the ink composition may adhere to the fabric to which the reaction solution composition is adhered in advance. The adhesion of the ink composition may be performed simultaneously with or after the adhesion of the reaction solution composition.

The ink composition adhesion step is a step of jetting the ink composition from an ink jet head using an ink jet method to make the ink composition adhere to at least the fabric to which the reaction solution composition is adhered. A dyed portion with a fine pattern can be easily and reliably formed by employing the ink jet method. Further, the ink jet method can be applied to various fabrics, and printing can be satisfactorily performed. In the textile printing method performed using such a recording method, printing with a small color difference between the front side and the rear side can be satisfactorily performed even on a thick fabric. Further, a printed material with more excellent wet rub fastness and color developability is easily obtained by performing recording on the fabric using the ink composition. Further, since the ink composition has excellent clogging properties, the printing can be stably continuously performed in the textile printing using the ink jet method.

Further, it is preferable that the adhesion method be performed with the same device as an ink jet recording device that performs the reaction solution composition adhesion step. In this case, adjustment is made such that the ink composition is jetted from a nozzle different from the nozzle of the recording head from which the reaction solution composition is jetted.

In the ink composition adhesion step, the maximum adhesion amount of the ink composition to the fabric is preferably 50 mg/cm² or greater and 200 mg/cm² or less and more preferably 80 mg/cm² or greater and 150 mg/cm² or less. When the maximum adhesion amount is in the above-described ranges, a printed material with more excellent wet rub fastness and color developability is obtained.

After the present step, the fabric to which at least the reaction solution composition is adhered may be heated and dried as necessary.

Examples of the heating method include a hot air drying method, a heat press method, a normal pressure steam method, a high-pressure steam method, and a thermofix method. Further, examples of a heat source for heating include warm air, infrared rays, and microwaves.

During the heating, the surface temperature of the heated fabric is preferably 60° C. or higher and 180° C. or lower. When the surface temperature is in the above-described range, damage to the ink jet head and to the fabric can be reduced, and the ink easily uniformly wet-spreads and easily permeates into the fabric. Further, the surface temperature can be measured using a non-contact thermometer (trade name “IT2-80”, manufactured by Keyence Corporation).

The heating time is, for example, preferably 5 seconds or longer and 10 minutes or shorter. When the heating time is in the above-described range, the fabric can be sufficiently heated while damage to the ink jet head and to the fabric is reduced.

### 5.3. Post-Treatment Liquid Composition Adhesion Step

It is preferable that the ink jet recording method further include a post-treatment liquid composition adhesion step of making the post-treatment liquid composition repeatedly adhere to at least the region of the fabric to which the ink composition is adhered. The post-treatment liquid composition adhesion step may be performed by an ink jet method of jetting an ink from a recording head or a non-ink jet method. Examples of the adhesion method performed using the non-ink jet method include coating a fabric by padding or using a padder. The post-treatment liquid composition adhesion step is performed simultaneously with or after the ink composition adhesion step. Further, the post-treatment liquid composition adhesion step may be performed simultaneously with the reaction solution composition adhesion step and the ink composition adhesion step. From the viewpoint that a fabric with more excellent wet rub fastness and color developability tends to be obtained, it is preferable that the post-treatment liquid composition contain particles containing an organopolysiloxane and water.

A fabric to which at least the reaction solution composition, the ink composition, and the post-treatment liquid composition are adhered is obtained by performing the present step. A printed material with more excellent wet rub fastness and color developability tends to be obtained by making the post-treatment liquid composition adhere to the fabric.

The fabric used for adhesion in the present step may be a fabric to which at least the reaction solution composition and the ink composition are adhered, and for example, the post-treatment liquid composition may adhere to the fabric to which the reaction solution composition and the ink composition are adhered in advance. The adhesion of the post-treatment liquid composition may be performed simultaneously with or after the adhesion of the ink composition. It is preferable that textile printing be performed such that the ink composition adheres to the fabric to which the reaction solution composition is adhered and then the post-treatment liquid composition adheres to the fabric to which the reaction solution composition and the ink composition are adhered. In this manner, a printed material with more excellent wet rub fastness and color developability tends to be obtained.

The method of making the post-treatment liquid composition adhere to the fabric may refer to the method of making the reaction solution composition adhere to the fabric.

The adhesion amount of the post-treatment liquid composition to the fabric is, for example, preferably 0.02 g/cm² or greater and 0.5 g/cm² or less and more preferably 0.02 g/cm² or greater and 0.3 g/cm² or less. When the adhesion amount of the post-treatment liquid composition is in the above-described ranges, a printed material with more excellent wet rub fastness and color developability tends to be obtained.

### 5.4. Drying Step

It is preferable that the ink jet recording method further include a drying step of heating and drying the fabric to which the reaction solution composition, the ink jet ink composition, and the post-treatment liquid composition are adhered, after the post-treatment liquid composition adhesion step. Further, the drying temperature in the drying step is preferably 160° C. or higher. The reaction solution composition, the ink composition, and the post-treatment liquid composition more suitably adhere to the fabric by performing the drying step so that the aggregation of the pigment can be more suitably carried out. Therefore, a printed material with more excellent wet rub fastness and color developability tends to be obtained. This tendency is more significant when the drying temperature in the drying step is 160° C. or higher.

The drying temperature is, for example, set to preferably 300° C. or lower and more preferably 200° C. or lower. In this manner, even when the fabric is colored with a dye in advance, sublimation of the dye due to the heating and drying is suppressed, and thus fading of the fabric color of the fabric can be suppressed.

The heating method and the heating time may refer to the heating method and the heating time in the ink composition adhesion step.

### 5.5. Other Steps

The ink jet recording method may further include a washing step of washing the printed material after the drying step. The components that have not adhered to the fabric can be removed when the recording method includes the present step.

The recording method may include other steps of making one or more selected from the group consisting of the reaction solution composition, the ink composition, and the post-treatment liquid composition adhere to the fabric as necessary. In this case, the order and the number of times of these steps are not limited, and the steps can be appropriately performed as necessary.

### 5.6. Ink Jet Recording Device

An ink jet recording device used for the ink jet recording method is not particularly limited as long as the ink jet recording device includes at least an ink container storing the ink composition and a recording head connected to the ink container and is capable of forming an image on a fabric by allowing the recording head to jet the ink composition. Further, it is preferable that the ink jet recording device include containers storing the reaction solution composition and/or the post-treatment liquid composition and a recording head connected thereto. In this case, the reaction solution composition and/or the post-treatment liquid composition can be made to adhere to the fabric by being jetted from the recording head.

Any of a serial type ink jet recording device or a line type ink jet recording device can be used as the ink jet recording device. These types of ink jet recording devices are equipped with a recording head. Such ink jet recording devices allow liquid droplets of the ink composition and preferably liquid droplets of the reaction solution composition and/or the post-treatment liquid composition, to be jetted intermittently from nozzle holes of the recording head at a predetermined timing with a predetermined volume while changing the relative positional relationship between the fabric and the recording head. In this manner, a predetermined transfer image can be formed by making the ink composition and preferably the reaction solution composition and/or the post-treatment liquid composition adhere to the fabric.

Typically, in the serial type ink jet recording device, a transport direction of the fabric which is a recording medium and a direction of a reciprocating movement of the recording head intersect with each other, and the relative positional relationship between the fabric and the recording head is changed by a combination of the reciprocating movement of the recording head and the transport movement of the fabric. Further, in this case, a plurality of nozzle holes are typically arranged in the recording head, and arrays of the nozzle holes, that is, nozzle arrays are formed in the transport direction of the fabric. In some cases, a plurality of nozzle arrays are formed in the recording head according to the kind or the number of the ink composition, the reaction solution composition, and/or the post-treatment liquid composition.

Further, typically, in the line type ink jet recording device, the recording head changes the relative positional relationship between the fabric and the recording head by changing the relative positional relationship between the fabric and the recording head using the transport of the fabric which is a recording medium without performing a reciprocating movement. Even in this case, a plurality of nozzle holes are typically arranged in the recording head, and nozzle arrays are formed in a direction intersecting the transport direction of the fabric.

In the recording method, it is preferable that the ink composition adhesion step be performed immediately after the adhesion of the reaction solution composition to the fabric and preferably within 1.5 seconds. Such a time interval may be realized by appropriately setting the disposition and the scanning speed of the recording head of the ink jet recording device to be used, the transport speed of the fabric, and the like.

### EXAMPLES

Hereinafter, the present disclosure will be described in detail with reference to the following examples, but the present disclosure is not limited thereto. Hereinafter, the term “parts” denotes parts by mass unless otherwise specified.

### 1. Preparation of Reaction Solution Composition

### Examples 1 to 13 and Comparative Examples 1 and 2

Each reaction solution composition was obtained by adding each component to a tank for a mixture to have the composition as listed in Table 1, mixing and stirring the mixture, and filtering the mixture through a PTFE membrane filter having a pore size of 5 μm.

The numerical value of the blending amount of each component in Table 1 denotes % by mass. Ion exchange water was used as water and added to the mixture such that the mass of each reaction solution composition reached 100% by mass. The content of the cationic urethane resin in Table 1 denotes the amount in terms of non-volatile content. Cationic urethane resin
620: SUPERFLEX (registered trademark) 620 (trade name, manufactured by DKS Co., Ltd., cationic ester-based urethane resin)
WBR-2122C: Urethane Emulsion WBR-2122C (trade name, manufactured by Taisei Fine Chemical Co., Ltd., cationic ester-based urethane resin)
650: SUPERFLEX (registered trademark) 650 (trade name, manufactured by DKS Co., Ltd., carbonate-based cationic urethane resin)

### Water-Soluble Organic Solvent

Glycerin (b.p.: 290° C.)
Triethylene glycol (b.p.: 287° C.)
Propylene glycol (b.p.: 188° C.)

### Surfactant

E1010: OLFINE (registered trademark) E1010 (trade name, manufactured by Nissin Chemical Co., Ltd.)

### Polyvalent Metal Salt

Magnesium sulfate

### 2. Preparation of Ink Composition

### Examples 1 to 13 and Comparative Examples 1 and 2

Each ink composition of the examples and the comparative examples was obtained by adding each component to a tank for a mixture to have the composition as listed in Table 2, mixing and stirring the mixture, and filtering the mixture through a PTFE membrane filter having a pore size of 5 μm.

The numerical value of the blending amount of each component in Table 2 denotes % by mass. Ion exchange water was used as water and added to the mixture such that the mass of each reaction solution composition reached 100% by mass. Each component listed in Table 2 is as follows. The content of the resin and the pigment in Table 2 denote the amounts in terms of non-volatile content.

### Pigment

CW-1: MICROJET (registered trademark) CW-1 (trade name, manufactured by Orient Chemical Industries Co., Ltd.) Resin
UW-1614AF: ETERNACALL (registered trademark) UW-1614AF (trade name, manufactured by UBE Corporation, crosslinkable urethane resin dispersion)
W-6061: TAKELAC (registered trademark) W-6061 (trade name, manufactured by Mitsui Chemicals Inc., non-crosslinkable urethane-based dispersion)

### Water-Soluble Organic Solvent

Glycerin
Triethylene glycol

### Surfactant

E1010: OLFINE (registered trademark) E1010 (trade name, manufactured by Nissin Chemical Co., Ltd.)

### pH Adjuster

Potassium hydroxide

### 3. Preparation of Post-Treatment Liquid Composition

### Examples 1 to 12 and Comparative Examples 1 and 2

Each post-treatment liquid composition was obtained by adding each component to a tank for a mixture to have the composition as listed in Table 3, mixing and stirring the mixture, and filtering the mixture through a PTFE membrane filter having a pore size of 5 μm. Further, the post treatment was not performed without preparing the post-treatment liquid composition in Example 13.

The numerical value of the blending amount of each component in Table 3 denotes % by mass. Ion exchange water was used as water and added to the mixture such that the mass of each post-treatment liquid composition reached 100% by mass. Each component listed in Table 3 is as follows. The content of the emulsion containing resin particles in Table 3 denotes the amount in terms of non-volatile content. Emulsion containing resin particles
POLON-MF-14: POLON (registered trademark)-MF-14 (trade name, manufactured by Shin-Etsu Chemical Co., Ltd., emulsion containing particles that contain amino-modified silicone)
K-45: HISOFTER K-45 (trade name, manufactured by Meisei Chemical Works, Ltd., emulsion containing particles that contain dimethyl silicone)
EX-200A: EX-200A (trade name, manufactured by Takamatsu oil & fat Co., Ltd., emulsion containing particles that contain polyester-based resin)

### 4. Preparation of Printed Material

### Examples 1 to 13 and Comparative Examples 1 and 2

Each of the reaction solution compositions, the ink compositions, and the post-treatment liquid compositions of Examples 1 to 13 and Comparative Examples 1 and 2 was used and made to adhere to a fabric. Specifically, a fabric to which the reaction solution composition, the ink composition, and the post-treatment liquid composition were adhered was obtained in the following manner. Further, a fabric to which the reaction solution composition and the ink composition were adhered was obtained in Example 13.

Thick white polyester twill serving as a fabric was coated with each reaction solution composition obtained in Examples 1 to 13 and Comparative Examples 1 and 2 by an ink jet method using an ink jet printer (trade name, PX-G930, manufactured by Seiko Epson Corporation). Further, the adhesion pattern was set to have a resolution of 1,440×1,440 dpi.

Next, each of the fabrics to which the reaction solution composition was adhered was coated with each of the ink composition obtained in Examples 1 to 13 and Comparative Examples 1 and 2 by an ink jet method using an ink jet printer (trade name, PX-G930, manufactured by Seiko Epson Corporation) without being dried. Thereafter, the fabric was temporarily dried at 100° C. for 3 minutes. Further, the adhesion pattern was set as a solid pattern with a resolution of 1,440×1,440 dpi and a jetting amount of 100% Duty.

Thereafter, each of the fabrics to which the reaction solution composition and the ink composition were adhered was coated with each of the post-treatment liquid compositions obtained in Examples 1 to 12 and Comparative Examples 1 and 2 using a padder. Next, the fabric was dried by being subjected to a heat treatment under the drying conditions listed in Table 4 using a conveyor oven, that is, a hot air drying method, thereby obtaining each printed material in Examples 1 to 12 and Comparative Examples 1 and 2. Further, the fabric to which the reaction solution composition and the ink composition were adhered was dried by being subjected to a heat treatment under the drying conditions listed in Table 4 using a conveyor oven, that is, a hot air drying method, thereby obtaining a printed material.

### 5. Evaluation of Printed Material

### 5.1. Color Developability

The L*a*b and OD_{BLACK} values of each of the printed materials of Examples 1 to 13 and Comparative Examples 1 and 2, obtained in the preparation of the printed material described above, were measured using a fluorescence spectrodensitometer (FD-7 (trade name), manufactured by Konica Minolta, Inc.). The color developability was evaluated according to the following evaluation criteria based on the obtained values. The results are listed in Table 5.

### Evaluation Criteria

A: The OD_{BLACK} value was 1.55 or greater.
B: The OD_{BLACK} value was 1.50 or greater and less than 1.55.
C: The OD_{BLACK} value was less than 1.50.

### 5.2. Wet Rub Fastness

The wet rub fastness of each of the printed materials of Examples 1 to 13 and Comparative Examples 1 and 2, obtained in the preparation of the printed material described above, was evaluated according to the following evaluation criteria in conformity with ISO 105 X12. Further, the test was performed by a crockmeter method. The results are listed in Table 5.

### Evaluation Criteria

S: The wet rub fastness was the grade 3-4 (intermediate grade) or higher.
A: The wet rub fastness was the grade 3.
B: The wet rub fastness was the grade 2-3 (intermediate grade).
C: The wet rub fastness was the grade 2 or lower.

### 5.3. Clogging Properties

An ink jet printer (trade name, PX-G930, manufactured by Seiko PMC Corporation) was charged with each of the reaction solution compositions of Examples 1 to 13 and Comparative Examples 1 and 2, and it was confirmed that the reaction solution composition was jetted from all ink jet heads. Thereafter, the printer filled with the reaction solution composition was allowed to stand in an environment of 40° C. for 1 week in a state where the ink jet head was shifted from the home position in the ink jet printer, that is, the ink jet head was shifted from the position of a cap provided in the ink jet printer and thus was not capped. After the standing, it was confirmed that the reaction solution composition was jetted from all the ink jet heads, and the clogging properties were evaluated according to the following evaluation criteria. The results are listed in Table 5.

### Evaluation Criteria

AA: Jetting of the reaction solution composition from all the ink jet heads was confirmed, and clogging did not occur.
A: Jetting of the reaction solution composition from all the ink jet heads was confirmed after the ink jet heads were cleaned once to three times, and clogging did not occur.
B: Jetting of the reaction solution composition from all the ink jet heads was confirmed after the ink jet heads were cleaned three or more times, and clogging did not occur.
C: Some ink jet heads did not jet the reaction solution composition even after being cleaned, and clogging occurred.

As listed in Table 5, according to the set of the present embodiment, it was found that a printed material with excellent wet rub fastness was obtained.

As shown in Examples 1, 5, and 8, it was found that clogging was difficult to occur when the reaction solution composition containing a water-soluble organic solvent having a boiling point of 260° C. or higher was used.

As shown in Examples 1 to 13, it was found that a printed material with excellent wet rub fastness was obtained when the content of the cationic urethane resin was 1.5% by mass or greater and 8.0% by mass or less with respect to the total amount of the reaction solution composition. Further, as shown in Examples 1 to 3, it was found that a printed material with more excellent wet rub fastness was obtained when the content of the cationic urethane resin was 2.0% by mass or greater with respect to the total amount of the reaction solution composition.

As shown in Examples 1 and 13, it was found that a printed material with more excellent wet rub fastness and color developability was obtained.

As shown in Examples 1 and 12, it was found that a printed material with more excellent wet rub fastness and color developability was obtained when the post-treatment liquid composition containing particles that contained an organopolysiloxane was used. Further, as shown in Examples 1 and 9, it was found that a printed material with more excellent wet rub fastness was obtained when the post-treatment liquid composition containing particles that contained amino-modified silicone and an organopolysiloxane was used.

As shown in Examples 1, 6, and 7, it was found that a printed material with more excellent wet rub fastness was obtained when the reaction solution composition containing a cationic ester-based urethane resin was used.

As shown in Examples 1 and 10, it was found that a printed material with more excellent color developability was obtained when the reaction solution composition containing a polyvalent metal salt was used.

As shown in Examples 1 and 11, it was found that a printed material with more excellent wet rub fastness was obtained when the drying temperature in the drying step after the post-treatment liquid composition adhesion step was set to 160° C. or higher.

What is claimed is:

1. A set comprising:
a reaction solution composition; and
an ink jet ink composition,
wherein the reaction solution composition contains a cationic urethane resin, a water-soluble organic solvent, and water,
the ink jet ink composition contains a pigment, a crosslinkable urethane resin, and water, and
the set is used to jet the reaction solution composition and the ink jet ink composition by an ink jet method to make the reaction solution composition and the ink jet ink composition adhere to a fabric.

2. The set according to claim 1,
wherein the water-soluble organic solvent includes a water-soluble organic solvent having a boiling point of 260° C. or higher.

3. The set according to claim 1,
wherein a content of the cationic urethane resin is 1.5% by mass or greater and 8.0% by mass or less with respect to a total amount of the reaction solution composition.

4. The set according to claim 1, further comprising:
a post-treatment liquid composition,
wherein the post-treatment liquid composition contains particles containing an organopolysiloxane, and water.

5. The set according to claim 4,
wherein the particles containing an organopolysiloxane include particles containing amino-modified silicone.

6. The set according to claim 1,
wherein the cationic urethane resin includes a cationic ester-based urethane resin.

7. The set according to claim 1,
wherein the reaction solution composition further contains a polyvalent metal salt.

8. The set according to claim 1,
wherein the fabric contains polyester.

9. An ink jet recording method comprising:
a reaction solution composition adhesion step of jetting the reaction solution composition included in the set according to claim 1 from a recording head to make the reaction solution composition adhere to a fabric; and
an ink jet ink composition adhesion step of jetting the ink jet ink composition included in the set according to claim 1 from the recording head to make the ink jet ink composition adhere to at least the fabric to which the reaction solution composition is adhered.

10. The ink jet recording method according to claim 9,
wherein the set further includes a post-treatment liquid composition that contains particles containing an organopolysiloxane, and water, and
the ink jet recording method further includes a post-treatment liquid composition adhesion step of making the post-treatment liquid composition adhere to at least the fabric to which the ink jet ink composition is adhered.

11. The ink jet recording method according to claim 10, further comprising:
a drying step of heating and drying the fabric to which the reaction solution composition, the ink jet ink composition, and the post-treatment liquid composition are adhered, after the post-treatment liquid composition adhesion step,
wherein a drying temperature in the drying step is 160° C. or higher.
